(19) United States
(12) Patent Application Publication
(10) Pub. No.: US 2016/0018954 A1
(43) Pub. Date: Jan. 21, 2016

(54) DATA PROCESSING METHOD AND ELECTRONIC DEVICE THEREOF

(71) Applicant: Samsung Electronics Co., Ltd, Suwon-si (KR)

(72) Inventors: Yong-Man PARK, Yongin-si (KR); Eun-Jung KIM, Seoul (KR); So-Young LEE, Seoul (KR); Yoon-Sun CHO, Seoul (KR); Hee-Kyoung CHOI, Seoul (KR)

(21) Appl. No.: 14/802,435

(22) Filed: Jul. 17, 2015

(30) Foreign Application Priority Data
Jul. 17, 2014 (KR) 10-2014-0090446

(51) Int. Cl. G06F 3/0481; H04L 12/58; G06F 3/0484

(52) U.S. Cl. CPC G06F 3/0481; G06F 3/04842; G06F 3/04847; H04L 51/043; H04L 51/24

(57) ABSTRACT

An operating method of an electronic device is provided. The operating method includes selecting an object displayed in a window and calling another window corresponding to the object on the basis of the selected object.

### CROSS-REFERENCE TO RELATED APPLICATION(S)

This application claims the benefit under 35 U.S.C. §119(a) of a Korean patent application filed on Jul. 17, 2014 in the Korean Intellectual Property Office and assigned Serial No. 10-2014-0090446, the entire disclosure of which is hereby incorporated by reference.

### TECHNICAL FIELD

The present disclosure relates to a method and device for providing a notification message in an electronic device.

### BACKGROUND

In order to switch a chat window, an electronic device may exit a running chat room and then switch (move) to another chat room in a chat list. Or, when there is a push notification during a chat, the electronic device may switch (move) to the corresponding chat room through the corresponding notification. However, in this case, the electronic device must exit a window of the current chat room (e.g., chat window) and move to a window of another chat room through an additional activity in order to switch to a new chat room, and then has to exit the window of the corresponding chat room in order to return to the previous chat room again.

The above information is presented as background information only to assist with an understanding of the present disclosure. No determination has been made, and no assertion is made, as to whether any of the above might be applicable as prior art with regard to the present disclosure.

### SUMMARY

An electronic device, when receiving a message from a companion while operating, displays a face icon of the corresponding companion on the upper side thereof to enable direct switching to a chat screen. However, there is a limitation in that receiving a push notification and moving to the chat screen when the corresponding messenger service is not used is inconvenient.

Aspects of the present disclosure are to address at least the above-mentioned problems and/or disadvantages and to provide at least the advantages described below. Accordingly, an aspect of the present disclosure is to provide an interface that allows a user to identify a message through easier and faster chat window switching in a messenger (or text message) service.

Another aspect of the present disclosure is to identify a new message faster by rapidly switching to the chat window including the new message.

Another aspect of the present disclosure is to support chat window switching in order to freely switch chat windows for a chat message and a Short Message Service (SMS) text message received from the same user in cases where the chat message and the SMS text message may be simultaneously transmitted to the same user in one service.

In accordance with an aspect of the present disclosure, an electronic device is provided. The electronic device includes a display and a processor configured to select an object displayed in a window and display, on the display, another window corresponding to the object on the basis of the selected object.

In accordance with another aspect of the present disclosure, an electronic device is provided. The electronic device includes a communication module configured to transmit/receive a message, a display configured to display a window, and a processor functionally coupled to the communication module and the display, wherein the processor may be configured to select an object displayed in the window and to display another window corresponding to the object on the display on the basis of the selected object.

In accordance with another aspect of the present disclosure, an operating method of an electronic device is provided. The operating method includes selecting an object displayed in a window and calling another window corresponding to the object on the basis of the selected object.

In accordance with another aspect of the present disclosure, an operating method of an electronic device is provided. The operating method includes displaying a window, displaying at least one object in the window, selecting the object displayed in the window, and calling and displaying another window corresponding to the object based on the selected object.

In accordance with another aspect of the present disclosure, a recording medium is provided. The recording medium includes a computer readable recording medium including a program for carrying out an operation of displaying a window, an operation of displaying at least one object in the window, an operation of selecting the object displayed in the window, and an operation of calling and displaying another window corresponding to the object on the basis of the selected object.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a block diagram of an electronic device according to various embodiments of the present disclosure;

FIG. 3 illustrates an operation of displaying an unidentified message of a chat program in an electronic device according to various embodiments of the present disclosure;

FIG. 4 illustrates an operation of switching a chat window of a chat program in an electronic device according to various embodiments of the present disclosure;

FIG. 5 illustrates an operation of displaying notification of an unidentified message of a chat program in an electronic device according to various embodiments of the present disclosure;

FIG. 6 illustrates an operation of changing an object displayed in a notification display area in an electronic device according to various embodiments of the present disclosure;

FIG. 7 illustrates an operation of controlling an object displayed in a notification area in an electronic device according to various embodiments of the present disclosure;

FIG. 8 illustrates an operation of displaying an object in a notification display area in an electronic device according to various embodiments of the present disclosure;

FIG. 9 illustrates an operation of controlling an object included in a notification display area in an electronic device according to various embodiments of the present disclosure;

FIG. 10 illustrates an operation of controlling a notification display area displayed in a chat window in an electronic device according to various embodiments of the present disclosure;

FIG. 11 illustrates an operation of displaying an object of a different program in a notification display area in an electronic device according to various embodiments of the present disclosure;

FIG. 12 illustrates an operation of displaying an object corresponding to a chat window of a different program in an electronic device according to various embodiments of the present disclosure;

FIG. 13 is a flowchart illustrating an operation of switching a chat window by selecting an object displayed in a notification display area in an electronic device according to various embodiments of the present disclosure; and

FIG. 14 is a flowchart illustrating an operation of calling another chat window based on a user input detected in a chat window in an electronic device according to various embodiments of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used in various embodiments of the present disclosure, the expressions “include”, “may include” and other conjugates refer to the existence of a corresponding disclosed function, operation, or constituent element, and do not limit one or more additional functions, operations, or constituent elements. Further, as used in various embodiments of the present disclosure, the terms “include”, “have”, and their conjugates are intended merely to denote a certain feature, numeral, operation, element, component, or a combination thereof, and should not be construed to initially exclude the existence of or a possibility of addition of one or more other features, numerals, operations, elements, components, or combinations thereof.

Further, as used in various embodiments of the present disclosure, the expression “or” includes any or all combinations of words enumerated together. For example, the expression “A or B” or “at least A or/and B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, without departing from the scope of the present disclosure, a first component element may be named a second component element. Similarly, the second component element also may be named the first component element.

When an element is referred to as being “coupled” or “connected” to any other element, it should be understood that not only the element may be coupled or connected directly to the other element, but also a third element may be interposed therebetween. Contrarily, when an element is referred to as being “directly coupled” or “directly connected” to any other element, it should be understood that no element is interposed therebetween.

The terms as used in various embodiments of the present disclosure are used merely to describe a certain embodiment and are not intended to limit the present disclosure. Furthermore, all terms used herein, including technical and scientific terms, have the same meaning as commonly understood by those of skill in the art to which the present disclosure pertains. Such terms as those defined in a generally used dictionary are to be interpreted to have the meanings equal to the contextual meanings in the relevant field of art, and are not to be interpreted to have ideal or excessively formal meanings unless clearly defined in various embodiments of the present disclosure.

An electronic device according to various embodiments of the present disclosure may be a device including a communication function. The electronic device according to various embodiments of the present disclosure may, for example, include at least one of a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical device, a camera, a wearable device (e.g., a head-mounted-device (HMD) such as electronic glasses, electronic clothing, an electronic bracelet, an electronic necklace, an electronic appcessory, an electronic tattoo, or a smart watch), a television (TV), a digital versatile disc (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an artificial intelligence robot, a TV, an electronic dictionary, an electronic key, a camcorder, medical equipment (e.g., a magnetic resonance angiography (MRA) machine, a magnetic resonance imaging (MRI) machine, a computed tomography (CT) scanner, or an ultrasonic machine), a navigation device, a global positioning system (GPS) receiver, an event data recorder (EDR), a flight data recorder (FDR), a vehicle infotainment device, electronic equipment for a ship (e.g., ship navigation equipment and a gyrocompass), avionics, security equipment, an industrial or home robot, a part of furniture or building/structure, an electronic board, an electronic signature receiving device, a projector, and various measuring instruments (e.g., a water meter, an electricity meter, a gas meter, or a wave meter). An electronic device according to various embodiments of the present disclosure may be a device including a fingerprint recognition sensor. The electronic device according to various embodiments of the present disclosure may be a combination of one or more of the aforementioned various devices. Further, the electronic device according to various embodiments of the present disclosure may be a flexible device. Further, it will be apparent to those skilled in the art that the electronic device according to various embodiments of the present disclosure is not limited to the aforementioned devices.

Hereinafter, an electronic device according to various embodiments of the present disclosure will be described with reference to the accompanying drawings. The term “user” as used in various embodiments of the present disclosure may indicate a person who uses an electronic device or a device (e.g., artificial intelligence electronic device) that uses an electronic device.

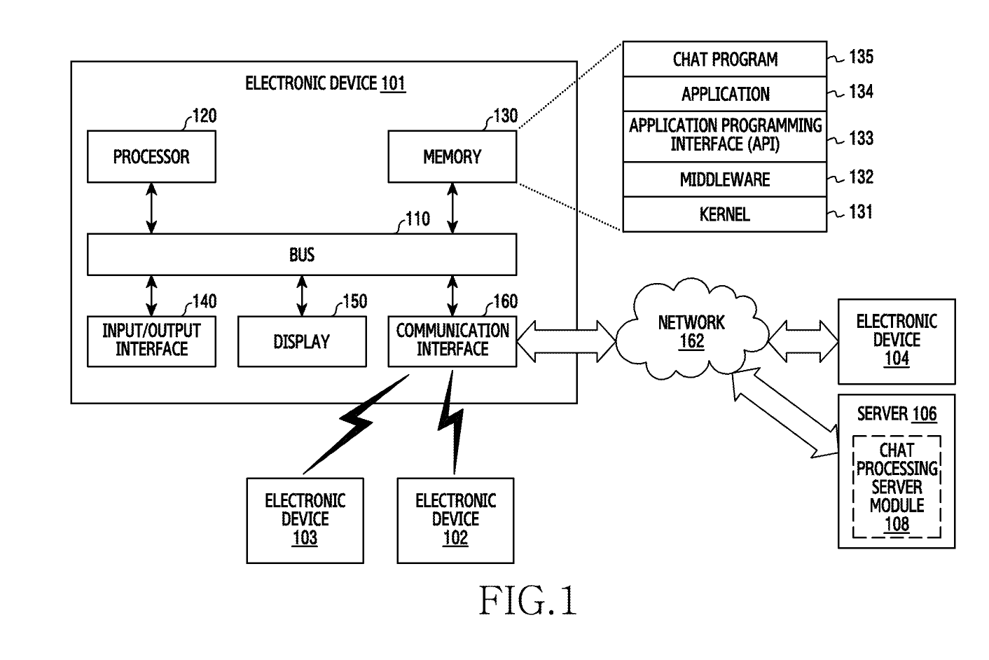

FIG. 1 illustrates a network environment including an electronic device according to various embodiments of the present disclosure.

Referring to FIG. 1, the electronic device 101 may include at least one of a bus 110, a processor 120, a memory 130, an input/output interface 140, a display 150, and a communication interface 160.

The bus 110 may be a circuit that interconnects the aforementioned elements and transfers communication signals (e.g., control messages) between the aforementioned elements.

The processor 120 may, for example, receive instructions from the aforementioned other elements (e.g., the memory 130, the input/output interface 140, the display 150, and the communication interface 160) via the bus 110, decode the received instructions, and perform calculations or data processing according to the decoded instructions.

At least one processor 120 may be included in the electronic device 101 to perform a predetermined function of the electronic device 101. According to an embodiment of the present disclosure, the processor 120 may include one or more Application Processors (APs) and one or more Micro Controller Units (MCUs). According to an embodiment of the present disclosure, the processor 120 may include one or more MCUs as applications or may be functionally connected to one or more MCUs. Referring to FIG. 1, the APs and the MCUs may be included in one Integrated Circuit (IC) package, or may be separately configured to be included in different IC packages, respectively. According to an embodiment of the present disclosure, the MCUs may be included in an IC package of the APs to be configured as one IC package together with the APs. Although the processor 120 includes the APs or the MCUs, it is only an embodiment for clear understanding, and it is apparent that the processor 120 may also perform operations of the APs and/or the MCUs.

The APs may drive an operating system or an application program to control a plurality of hardware or software elements connected thereto, and may process various types of data including multimedia data and perform calculations. The APs may be implemented by, for example, a System on Chip (SoC). According to an embodiment of the present disclosure, the processor 120 may further include a Graphic Processing Unit (GPU) (not illustrated).

The MCUs may be processors configured to perform a predetermined operation. According to an embodiment of the present disclosure, the MCUs may acquire sensing information through one or more specified motion sensors (e.g., a gyro sensor, an acceleration sensor, or a geomagnetic sensor), compare the acquired sensing information, and determine the operating state of the specified sensor by making reference to a database of the electronic device 101.

According to an embodiment of the present disclosure, the APs or the MCUs may load instructions or data received from at least one of a non-volatile memory and other elements connected to each of the APs and the MCUs in a volatile memory, and may process the loaded instructions or data. Furthermore, the APs or the MCUs may store data received from or generated by at least one of the other elements in a non-volatile memory.

The memory 130 may store instructions or data received from or generated by the processor 120 or the other elements (e.g., the input/output interface 140, the display 150, and the communication interface 160). The memory 130 may include programming modules, for example, a kernel 131, middleware 132, an Application Programming Interface (API) 133, applications 134, or the like. The above-described programming modules may be configured with software, firmware, hardware, or a combination of two or more thereof.

The kernel 131 may control or manage the system resources (e.g., the bus 110, the processor 120, and the memory 130) used to execute operations or functions implemented in the remaining programming modules, for example, the middleware 132, the API 133, and the applications 134. In addition, the kernel 131 may provide an interface through which the middleware 132, the API 133, or the applications 134 may access the individual elements of the electronic device 101 to control or manage the same.

The middleware 132 may function as a relay that enables the API 133 or the applications 134 to communicate with the kernel 131 for data transfer. In addition, in regard to task requests received from the applications 134, the middleware 132 may perform a control (e.g., scheduling or load balancing) for the task requests, using a method of assigning, to at least one of the applications 134, a priority for using the system resources (e.g., the bus 110, the processor 120, and the memory 130) of the electronic device 101.

The API 133 is an interface through which the applications 134 control functions provided from the kernel 131 or the middleware 132 and may include, for example, at least one interface or function (e.g., an instruction) for file control, window control, image processing, text control, or the like.

The applications 134 may include a short message service (SMS)/multimedia message service (MMS) application, an e-mail application, a calendar application, an alarm application, a health care application (e.g., application for monitoring physical activity or blood glucose), and an environmental information application (e.g., application for providing atmospheric pressure, humidity, or temperature information). The applications (or processors) 134 may correspond to an application associated with an information exchange between the electronic device 101 and an external electronic device (e.g., an electronic device 102, an electronic device 103, or an electronic device 104). The application related to the information exchange may include, for example, a notification relay application for transferring particular information to an external electronic device or a device management application for managing an external electronic device. The notification relay application may, for example, include a function of transferring, to an external electronic device (e.g., the electronic device 104), notification information generated by other applications (e.g., an SMS/MMS application, an e-mail application, a health management application, or an environmental information application) of the electronic device 101. Additionally or alternatively, the notification relay application may receive notification information from, for example, the external electronic device (e.g., the electronic device 104) and provide the received notification information to a user. For example, the device management application may manage (e.g., install, delete, or update) functions for at least a part of the external electronic device (e.g., the electronic device 104) communicating with the electronic device 101 (e.g., turning on/off the external electronic device itself (or some elements thereof) or adjusting the brightness (or resolution) of a display), applications operating in the external electronic device, or services (e.g., a telephone call service or a message service) provided from the external electronic device. According to various embodiments of the present disclosure, the applications 134 may include an application designated according to the attribute (e.g., the type) of the external electronic device (e.g., the electronic device 102, 103, or 104). For example, when the external electronic device is an MP3 player, the applications 134 may include an application related to the reproduction of music. Similarly, when the external electronic device is a mobile medical appliance, the applications 134 may include an application related to health care. According to an embodiment of the present disclosure, the applications 134 may include at least one of an application designated to the electronic device 101 and an application received from the external electronic device (e.g., a server 106 or the electronic device 104). A chat program 135 may be provided while being included in the applications 134, or may be stored as a separate program in the memory 130.

The chat program 135 may select an object displayed in a window and display another window connected to (i.e., corresponding to) the object on the display 150 based on the selected object. The chat program 135 may display content, as an object, which corresponds to a window including an unidentified message. The chat program 135 may display the number of unidentified messages included in the window together with the object. The chat program 135 may select an object using an input detected in a notification display area for displaying objects in the window or an area other than the notification display area. When detecting an input in the area other than the notification display area, the chat program 135 may select an object prior to (e.g., on the left side of) or subsequent to (on the right side of) an object corresponding to the window displayed in the notification display area on the basis of the input selected in the area. The chat program 135 may display an object when being set to display or always display an unidentified message in the window corresponding to the object. The chat program 135 may display content, as an object, which corresponds to a window provided by another program. The chat program 135 may further include an operation of changing the location where an object is displayed.

The input/output interface 140 may transfer instructions or data, input from a user through an input/output device (e.g., various sensors, such as an acceleration sensor or a gyro sensor, and/or a device such as a keyboard or a touch screen), to the processor 120, the memory 130, or the communication interface 160 through the bus 110. For example, the input/output interface 140 may provide the processor 120 with data on a user's touch input through a touch screen. Furthermore, the input/output interface 140 may output instructions or data, received from, for example, the processor 120, the memory 130, or the communication interface 160 via the bus 110, through an output unit (e.g., a speaker or the display 150). For example, the input/output interface 140 may output voice data processed by the processor 120 to the user through a speaker.

The display 150 may display various types of information (e.g., multimedia data, text data or the like.) to a user. In addition, the display 150 may include an input unit and may also be configured with a touch screen to which an instruction is input by a touch or proximity touch of the input unit on the display 150.

The communication interface 160 may establish a communication connect between the electronic device 101 and an external device (e.g., the electronic device 104 or the server 106). For example, the communication interface 160 may communicate with an external device while being connected to a network 162 through wireless communication or wired communication. The wireless communication may include at least one of, for example, Wi-Fi, Bluetooth (BT), Near Field Communication (NFC), GPS and cellular communication (for example Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), etc.). The wired communication may include at least one of, for example, a Universal Serial Bus (USB), a High Definition Multimedia Interface (HDMI), a Recommended Standard 232 (RS-232), and a Plain Old Telephone Service (POTS).

According to an embodiment of the present disclosure, the network 162 may be a communication network. The communication network may include at least one of a computer network, the Internet, the Internet of Things, and a telephone network. According to an embodiment of the present disclosure, a protocol (e.g., a transport layer protocol, data link layer protocol, or a physical layer protocol) for communication between the electronic device 101 and the external device may be supported by at least one of the applications 134, the API 133, the middleware 132, the kernel 131, and the communication interface 160.

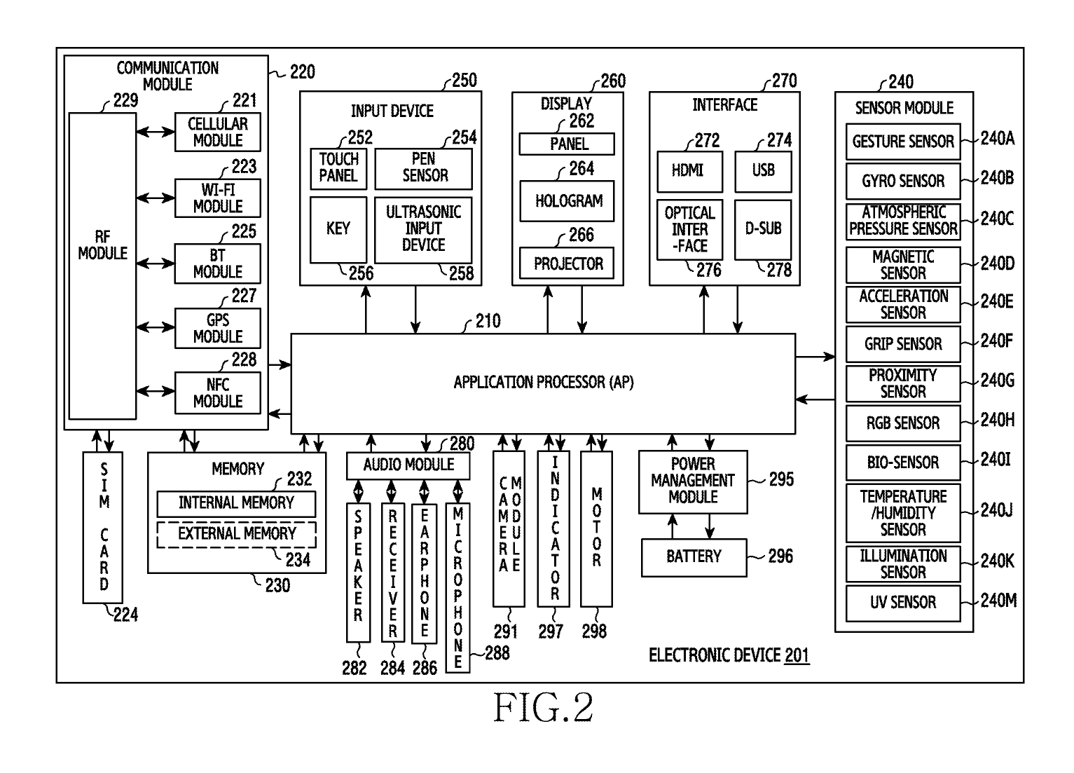

According to an embodiment of the present disclosure, the server 106 may support the driving of the electronic device 101 by performing at least one operation (or function) implemented in the electronic device 101. For example, the server 106 may include the processor 120 that controls the electronic device 101 to perform various embodiments of the present disclosure to be described below or a server module (e.g., a server controller or a server processor, not illustrated) that may support a particular module designated to perform the various embodiments of the present disclosure. For example, the server module may include at least one element of the processor 120 or the particular module to perform at least one of the operations that the processor 120 or the particular module performs (or to act on behalf of the processor 120 or the particular module). According to various embodiments of the present disclosure, the server module may be represented as a chat processing server module 108 of FIG. 1. Additional information may be provided through FIGS. 2 to 14 to be described below.

FIG. 2 is a block diagram of an electronic device according to various embodiments of the present disclosure.

The electronic device 201 may constitute, for example, the entirety or a part of the electronic device 101 illustrated in FIG. 1, or may expand all or some elements of the electronic device 101.

Referring to FIG. 2, the electronic device 201 may include at least one processor (e.g., application processor) 210, a communication module 220, a Subscriber Identification Module (SIM) card 224, a memory 230, a sensor module 240, an input device 250, a display 260, an interface 270, an audio module 280, a camera module 291, a power management module 295, a battery 296, an indicator 297, or a motor 298.

The processor 210 may be included in the electronic device 101 to perform a predetermined function of the electronic device 101. According to an embodiment of the present disclosure, the processor 210 may include one or more APs and one or more MCUs. According to an embodiment of the present disclosure, the processor 210 may include one or more micro controller units as applications, or may be functionally connected to one or more MCUs. Referring to FIG. 2, the APs and the MCUs may be included in one IC package, or may be separately configured to be included in different IC packages, respectively. According to an embodiment of the present disclosure, the MCUs may be included in an IC package of the APs to be configured as one IC package together with the APs. Although the processor 210 includes the APs or the MCUs, it is only an embodiment for clear understanding, and it is apparent that the processor 210 may also perform operations of the APs and/or the MCUs.

The APs may drive an operating system or an application program to control a plurality of hardware or software elements connected thereto, and may process various types of data including multimedia data and perform calculations. The APs may be implemented by, for example, an SoC. According to an embodiment, the processor 210 may further include a GPU (not illustrated).

The MCUs may be a processors configured to perform a predetermined operation. According to an embodiment of the present disclosure, the MCUs may acquire sensing information through one or more specified motion sensors (e.g., a gyro sensor 240B, an acceleration sensor 240E, or a geomagnetic sensor (not illustrated)), compare the acquired sensing information, and determine the operating state of the specified sensor (e.g., the geomagnetic sensor) by making reference to a database of the electronic device 201. In addition, although the MCUs and the elements of the sensor module 240 are illustrated as separate elements in FIG. 2, the MCUs may be implemented to include at least some of the elements of the sensor module 240 (e.g., at least one of the gyro sensor 240B, the acceleration sensor 240E, and the geomagnetic sensor).

According to an embodiment of the present disclosure, the APs or the MCUs may load instructions or data received from at least one of a non-volatile memory and other elements connected to each of the APs and the MCUs in a volatile memory, and may process the loaded instructions or data. Furthermore, the APs or the MCUs may store data received from or generated by at least one of the other elements in a non-volatile memory.

The communication module 220 (e.g., the communication interface 160) may perform data transmission/reception in communication between the electronic device 101 and the other electronic devices (e.g., the electronic device 102 or 104, or the server 106) connected thereto through a network. According to an embodiment of the present disclosure, the communication module 220 may include a cellular module 221, a Wi-Fi module 223, a BT module 225, a GPS module 227, an NFC module 228, and a Radio Frequency (RF) module 229.

The cellular module 221 may provide a voice call service, a video call service, a text message service, or an Internet service through a communication network (e.g., LTE, LTE-A, CDMA, WCDMA, UMTS, WiBro, or GSM). Furthermore, the cellular module 221 may distinguish between and authenticate electronic devices within a communication network using, for example, a SIM (e.g., the SIM card 224). According to an embodiment of the present disclosure, the cellular module 221 may perform at least some of the functions that the AP 210 may provide. For example, the cellular module 221 may perform at least some of the multimedia control functions.

According to an embodiment of the present disclosure, the cellular module 221 may include a Communication Processor (CP). Furthermore, the cellular module 221 may be implemented by, for example, an SoC. Although the elements such as the cellular module 221 (e.g., a CP), the memory 230, and the power management module 295 are illustrated to be separate from the AP 210 in FIG. 2, the AP 210 may include at least some of the aforementioned elements (e.g., the cellular module 221) according to an embodiment of the present disclosure.

According to an embodiment of the present disclosure, the AP 210 or the cellular module 221 (e.g., the CP) may load instructions or data, received from a non-volatile memory or at least one of the other elements connected thereto, to a volatile memory and process the loaded instructions or data. Furthermore, the AP 210 or the cellular module 221 may store data received from or generated by at least one of the other elements in a non-volatile memory.

The Wi-Fi module 223, the BT module 225, the GPS module 227, and the NFC module 228 may include a processor for processing data transmitted/received through the corresponding module. Referring to FIG. 2, the cellular module 221, the Wi-Fi module 223, the BT module 225, the GPS module 227, and the NFC module 228 are illustrated as separate blocks. However, according to an embodiment of the present disclosure, at least some (e.g., two or more) of the cellular module 221, the Wi-Fi module 223, the BT module 225, the GPS module 227, and the NFC module 228 may be included in one IC or one IC package. For example, at least some (e.g., the CP corresponding to the cellular module 221 and the Wi-Fi processor corresponding to the Wi-Fi module 223) of the processors corresponding to the cellular module 221, the Wi-Fi module 223, the BT module 225, the GPS module 227, and the NFC module 228 may be implemented as one SoC.

The RF module 229 may transmit/receive data, for example, RF signals. Although not illustrated in the drawing, the RF module 229 may, for example, include a transceiver, a Power Amplifier Module (PAM), a frequency filter, a Low Noise Amplifier (LNA), or the like. In addition, the RF module 229 may further include an element for transmitting/receiving electronic waves over free air space in wireless communication, for example, a conductor, a conducting wire, or the like. In FIG. 2, the cellular module 221, the Wi-Fi module 223, the BT module 225, the GPS module 227, and the NFC module 228 share one RF module 229. However, according to an embodiment of the present disclosure, at least one of them may transmit/receive an RF signal through a separate RF module.

The SIM card 224 may be a card including a SIM, and may be inserted into a slot formed in a predetermined location of the electronic device. The SIM card 224 may include unique identification information (e.g., an IC card identifier (ICCID)) or subscriber information (e.g., an international mobile subscriber identity (IMSI)).

The memory 230 (e.g., the memory 130) may include an internal memory 232 or an external memory 234. The internal memory 232 may include at least one of a volatile memory (e.g., a Dynamic Random Access Memory (DRAM), a Static RAM (SRAM), a Synchronous DRAM (SDRAM), or the like) or a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, or the like).

According to an embodiment of the present disclosure, the internal memory 232 may be a Solid State Drive (SSD). The external memory 234 may further include a flash drive, for example, a Compact Flash (CF), a Secure Digital (SD), a Micro-SD, a Mini-SD, an extreme Digital (xD), a memory stick, or the like. The external memory 234 may be functionally connected to the electronic device 201 through various interfaces. According to an embodiment of the present disclosure, the electronic device 201 may further include a storage device (or storage medium) such as a hard disc drive.

The sensor module 240 may measure a physical quantity or sense an operating state of the electronic device 201, and may convert the measured or sensed information into an electric signal. The sensor module 240 may include at least one of, for example, a gesture sensor 240A, the gyro sensor 240B, an atmospheric pressure sensor 240C, a magnetic sensor 240D, the acceleration sensor 240E, a grip sensor 240F, a proximity sensor 240G, a color sensor 240H (e.g., red, green, and blue (RGB) sensor), a biometric sensor 240I, a temperature/humidity sensor 240J, an illumination sensor 240K, and an Ultra Violet (UV) sensor 240M. Additionally or alternatively, the sensor module 240 may, for example, include an E-nose sensor (not illustrated), an electromyography (EMG) sensor (not illustrated), an electroencephalogram (EEG) sensor (not illustrated), an electrocardiogram (ECG) sensor (not illustrated), an Infrared (IR) sensor (not illustrated), an iris sensor (not illustrated), a fingerprint sensor (not illustrated), and the like. The sensor module 240 may further include a control circuit for controlling one or more sensors included therein.

The input device 250 may include a touch panel 252, a (digital) pen sensor 254, a key 256, or an ultrasonic input device 258. The touch panel 252 may detect a touch input in at least one of, for example, a capacitive type, a resistive type, an infrared type, and an acoustic wave type. The touch panel 252 may further include a control circuit. In case of the capacitive type touch panel, physical contact or proximity detection is possible. The touch panel 252 may further include a tactile layer. In this case, the touch panel 252 may provide a user with a tactile reaction.

The (digital) pen sensor 254 may be implemented, for example, using the same or a similar method to receiving a user's touch input or using a separate recognition sheet. The key 256 may include, for example, a physical button, an optical key, or a keypad. The ultrasonic input device 258 may identify data by detecting an acoustic wave with a microphone (e.g., a microphone 288) of the electronic device 201 through an input unit generating an ultrasonic signal, and may perform wireless detection. According to an embodiment of the present disclosure, the electronic device 201 may also receive a user input from an external device (e.g., a computer or server) connected thereto using the communication module 220.

The display 260 (e.g., the display 150) may include a panel 262, a hologram device 264, or a projector 266. The panel 262 may be, for example, a Liquid Crystal Display (LCD), an Active Matrix Organic Light Emitting Diode (AM-OLED), or the like. The panel 262 may be implemented to be, for example, flexible, transparent, or wearable. The panel 262 may be formed as a single module together with the touch panel 252. The hologram device 264 may show a three dimensional image in the air using an interference of light. The projector 266 may display an image by projecting light onto a screen. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 160 illustrated in FIG. 1. Additionally or alternatively, the interface 270 may include, for example, a Mobile High-definition Link (MHL) interface, an SD card/Multi-Media Card (MMC) interface, or an Infrared Data Association (IrDA) standard interface.

The audio module 280 may bilaterally convert a sound and an electrical signal. At least some elements of the audio module 280 may be included in, for example, the input/output interface 140 illustrated in FIG. 1. The audio coder/decoder (codec) 280 may process voice information input or output through, for example, a speaker 282, a receiver 284, earphones 286, or the microphone 288.

The camera module 291 is a device for capturing still and moving images, and may include one or more image sensors (e.g., a front sensor or a rear sensor), a lens (not illustrated), an image signal processor (ISP, not illustrated), or a flash (e.g., an LED or a xenon lamp, not illustrated) according to an embodiment of the present disclosure.

The power management module 295 may manage the power of the electronic device 201. Although not illustrated, the power management module 295 may include, for example, a Power Management IC (PMIC), a charger IC, or a battery or fuel gauge. According to various embodiments of the present disclosure, the PMIC may be mounted to an integrated circuit or an SoC semiconductor. Charging methods may be classified into a wired charging method and a wireless charging method. The charger IC may charge a battery and may prevent an over-voltage or over-current from being introduced from a charger.

According to an embodiment of the present disclosure, the charger IC may include a charger IC for at least one of the wired charging and the wireless charging. Examples of the wireless charging may include magnetic resonance charging, magnetic induction charging, and electromagnetic charging, and an additional circuit, such as a coil loop, a resonance circuit, and a rectifier, may be added for the wireless charging.

The battery gauge may measure, for example, a residual quantity of the battery 296, and a voltage, a current, or a temperature, for example while charging. The battery 296 may store or generate electricity and may supply power to the electronic device 201 using the stored or generated electricity. The battery 296 may include, for example, a rechargeable battery or a solar battery.

The indicator 297 may display a specific state of the electronic device 201 or a part thereof (e.g., the AP 210), for example, a boot-up state, a message state, or a state of charge (SOC). A motor 298 may convert an electrical signal into a mechanical vibration. Although not illustrated, the electronic device 201 may include a processing device (e.g., a GPU) for supporting mobile TV. The processing unit for supporting mobile TV may process, for example, media data pursuant to a certain standard of Digital Multimedia Broadcasting (DMB), Digital Video Broadcasting (DVB), or media flow.

Each of the above described elements of the electronic device according to various embodiments of the present disclosure may include one or more components, and the name of a corresponding element may vary according to the type of electronic device. The electronic device according to various embodiments of the present disclosure may include at least one of the above described elements and may exclude some of the elements or further include other additional elements. Further, some of the elements of the electronic device according to various embodiments of the present disclosure may be coupled to form a single entity while performing the same functions as those of the corresponding elements before the coupling.

According to various embodiments of the present disclosure, an electronic device may include a communication module for transmitting/receiving a message, a display for displaying a window, and a processor functionally coupled to the communication module and the display, wherein the processor may be set to select an object displayed in the window and to display another window connected to (i.e., corresponding to) the object on the display on the basis of the selected object.

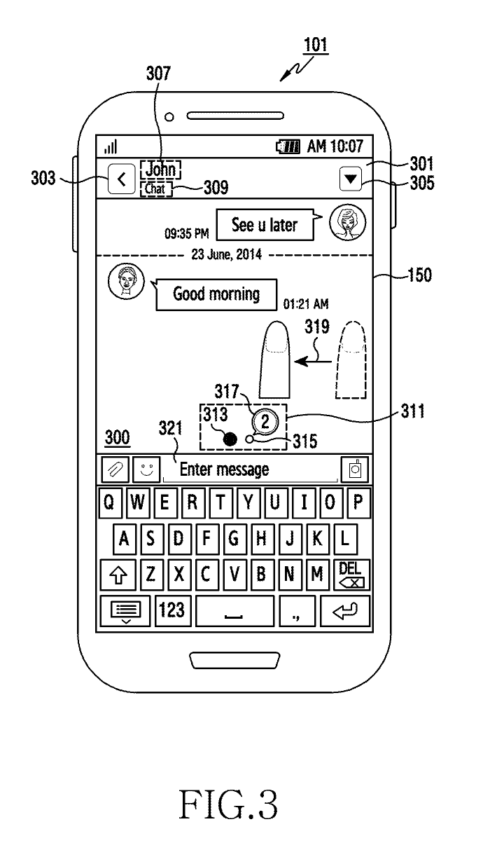

FIG. 3 illustrates an operation of displaying an unidentified message of a chat program in an electronic device according to various embodiments of the present disclosure.

According to various embodiments of the present disclosure, the electronic device 101 may display a notification message for a message received while transmitting/receiving one-to-one chat messages to/from a counterpart (e.g., the counterpart electronic device 102) (for example, during a chat) through a chat program (e.g., the chat program 135). According to an embodiment of the present disclosure, the electronic device 101 may be chatting with a particular counterpart, John (or the counterpart electronic device 102 corresponding to John). For example, the electronic device 101, while chatting with John in a one-to-one manner (e.g., while exchanging one-to-one chat messages with John), may display the transmitted/received messages in a chat window (or a chat room) corresponding to John based on the chat program 135.

Referring to FIG. 3, the electronic device 101 may create a chat window 300 for a chat with a counterpart based on the chat program 135 and transmit/receive messages to/from at least one particular counterpart through the chat window. According to various embodiments of the present disclosure, the chat window 300 may include an area 301 for displaying information of the chat window 300. The area 301 for displaying the information of the chat window 300 may include at least one of an area for displaying information on a chat counterpart (e.g., John 307), an area for displaying the attribute of the chat window 300 (e.g., Chat 309), and menu icons 303 and 305 for providing at least one function that can be controlled in the chat window 300. According to various embodiments of the present disclosure, the chat window 300 may include a message input area 321 for inputting a message, and the message input area 321 may be provided to be adjacent to a keypad.

While the chat window 300 of John 307 is open, the electronic device 101 may identify an unidentified message among the messages transmitted by another counterpart of the chat program 135 or may receive a new chat message from at least one other counterpart. In this case, the electronic device 101 may display information on the unidentified message (e.g., a message in a state where the corresponding chat window is not open based on a user input) or the newly received message (hereinafter, referred to as an unidentified message) at a designated location 311 (e.g., a notification display area) in the chat window 300 of John 307. For example, in cases where the electronic device 101 identifies an unidentified message in the chat program 135 while the chat window 300, through which the electronic device is chatting with John 307, is open, the electronic device 101 may display information on the corresponding message in a designated area for displaying a message status in the open chat window 300 of John 307.

According to an embodiment of the present disclosure, the electronic device 101 may display an object (or indicator) 315 (e.g., an icon or text) for a chat window including an unidentified message at the designated location 311 (hereinafter, referred to as the notification display area) of the chat window 300, and may display the number of unidentified messages 317 included in the chat window corresponding to the displayed object 315 (received from another counterpart in the chat window). When displaying the object 315 for the chat window in the notification display area 311, the electronic device 101 may display an object 315 for the current chat window 300 together.

According to various embodiments of the present disclosure, the objects 315 and 317 may be displayed to correspond to the current chat window (e.g., the chat window currently displayed on the display 150) and the number of chat windows including an unidentified message. For example, when it is assumed that there are three chat windows including an unidentified message, a total of four objects, including the object for the current chat window and three objects for the three chat windows, may be provided. When displaying a chat window on the display 150 in the chat program 135, the electronic device 101 may allow the chat window 300 being displayed on the display 150 or a chat window including an unidentified message to be distinguished through the object 313 or 315 included in the notification display area 311. In various embodiments of the present disclosure, the object corresponding to the current chat window (e.g., the chat window currently displayed on the display 150) may be displayed to be distinguished from an object for another chat window. For example, the object for the current chat window (e.g., the object 313) may be provided as a solid circular icon, and the object for the other chat window (e.g., the object 315) may be provided as a hollow circular icon. According to an embodiment of the present disclosure, the electronic device 101 may distinguish between the chat windows by differentiating the characteristic of the object 313 (e.g., the color or size of a mark) for the chat window 300 currently displayed on the display 150 from that of the object (e.g., the object 315) for the other chat window.

According to various embodiments of the present disclosure, the electronic device 101 may detect an input for movement to the other chat window (e.g., the chat window corresponding to the object 315) displayed in the notification display area 311. According to an embodiment of the present disclosure, the electronic device 101, when detecting a user input for switching the chat window 300 to the other chat window, may change (switch) the chat window 300 to the chat window corresponding to the object for which the user input is detected. For example, referring to the objects for the chat windows displayed in the notification display area 311 of the chat window 300 in FIG. 3, two objects 313 and 315 corresponding to two chat windows (e.g., the current chat window and the chat window through which an unidentified message is received) may be displayed. According to an embodiment of the present disclosure, the object 313 corresponding to the current chat window 300 and the object 315, on the right side of the object 313, for the other chat window where an unidentified message is received may be displayed. In addition, the number of unidentified messages 317 (e.g., two) may be displayed through an area adjacent to the object 315. According to an embodiment of the present disclosure, the electronic device 101 may provide the number of unidentified messages in conjunction with the corresponding object (e.g., the object 315). For example, the number of unidentified messages may be displayed to overlap with a space adjacent to the object or at least a portion of the object.

According to various embodiments of the present disclosure, the electronic device 101, when detecting a gesture 319 input to the display 150, may switch to the chat window of the object 315 displayed on the right side of the object 313 corresponding to the currently displayed chat window 300. In various embodiments of the present disclosure, the switching operation may be an operation of cancelling the display of the chat window 300 on the display 150 of the electronic device 101 and displaying the other chat window corresponding to the object 315. Alternatively, the switching operation may include an operation of displaying the other chat window in such a manner that the currently displayed chat window 300 is overlapped or overlaid with the other chat window. Furthermore, in various embodiments of the present disclosure, the operation of switching the chat window may also be illustrated as an operation of changing the chat window, an operation of activating the other chat window, an operation of calling the other chat window, or the like.

In various embodiments of the present disclosure, the gesture 319 may be a gesture set in response to an input for changing the chat window (e.g., a page) displayed on the display 150. For example, the gesture set in response to the input for changing the page may be a touch and drag input from a particular point of the display 150 of the electronic device 101 (e.g., the right or left edge of the display 150) to a point opposite to the particular point (e.g., the left or right edge of the display 150). For example, the gesture 319 in FIG. 3 may be a gesture (e.g., a touch and leftward drag) set in response to an input for flipping the page displayed on the display 150 rightward.

In various embodiments of the present disclosure, the chat window is only for clearly describing the embodiments of the present disclosure and, without being limited thereto, may include the meaning of a layer or window that may distinguish the boundary of content when the content is displayed on the display 150 of the electronic device 101. Likewise, the program including the above-described chat window (e.g., the layer or window) is also not limited to the chat program 135 and may represent a program that may display a window on the display 150 of the electronic device 101.

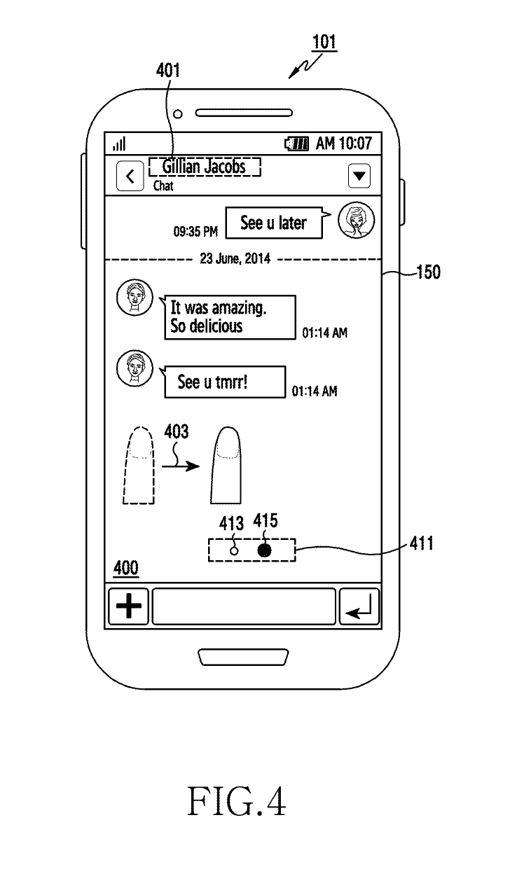

FIG. 4 illustrates an operation of switching a chat window of a chat program in an electronic device according to various embodiments of the present disclosure.

Referring to FIG. 4, the electronic device 101, when detecting a gesture for switching a chat window, such as the gesture 319 of FIG. 3, may switch the chat window displayed on the display 150 based on the detected gesture. The electronic device 101, when detecting the gesture 319 of FIG. 3, may switch the chat window to a chat window 400 of Gillian Jacobs 401 corresponding to the object 315 on the right side of the object 313 and display the chat window 400. The electronic device 101, when switching the chat window and then identifying two unidentified messages received from Gillian Jacobs 401, may cancel (remove) the display of the number of unidentified messages 317 in the notification display area (e.g., reference numeral 311 of FIG. 3). For example, the electronic device 101 may cancel the display of the number of unidentified messages 317 adjacent to the object 315 displayed in the notification display area 311 of FIG. 3 and display an object 415 in a notification display area 411 of FIG. 4. In addition, the electronic device 101 may display the object 415, corresponding to the chat window 400 being displayed on the display 150, differently from an object (e.g., an object 413) corresponding to another chat window (e.g., the chat window 300).

According to various embodiments of the present disclosure, the electronic device 101 may switch the chat window displayed on the display 150 using the gesture (e.g., the gesture 319) illustrated in FIG. 3. According to an embodiment of the present disclosure, when displaying an object (not illustrated), corresponding to at least one other chat window, on the right side of the object 415 for the chat window 400 displayed on the display 150, the electronic device 101 may switch the chat window 400, which is being displayed on the display 150 when the gesture 319 is detected, to the chat window corresponding to the relevant object.

When detecting a gesture 403 while displaying the chat window on the display 150, the electronic device 101 may switch the chat window 400 to the chat window of the object 413 displayed on the left side of the object 415 corresponding to the chat window 400. Here, the gesture 403 may be a gesture set in response to an input for flipping the page displayed on the display 150 leftward. The gesture set in response to the input for flipping the page leftward may be a touch and leftward drag to a designated distance from the left edge of the display 150 of the electronic device 101. The electronic device 101 may switch the chat window 400 displayed on the display 150 to the chat window corresponding to the object 413 (e.g., the chat window 300 of FIG. 3 corresponding to the object 413) when detecting an input for selecting (e.g., touching) the object 413 displayed on the display 150, in addition to when detecting the gesture 403.

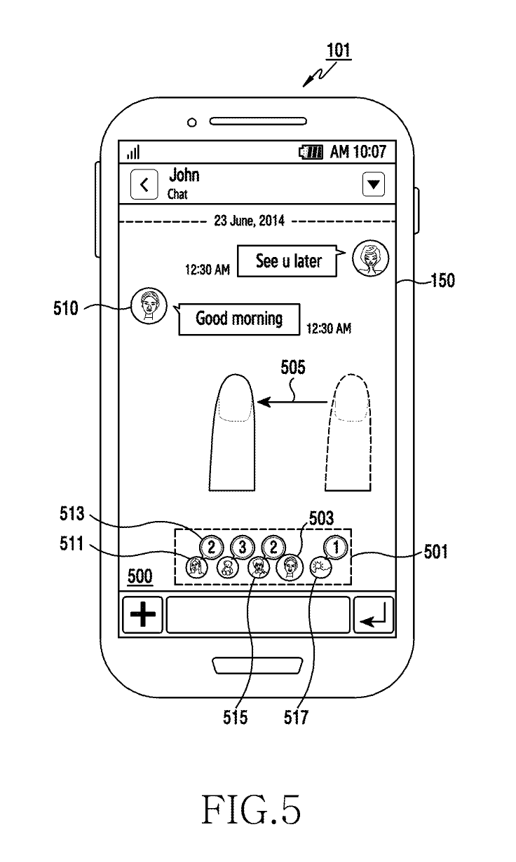

FIG. 5 illustrates an operation of displaying notification of an unidentified message of a chat program in an electronic device according to various embodiments of the present disclosure.

Referring to FIG. 5, the electronic device 101 may receive a message from at least one other electronic device (e.g., the electronic device 102) through the chat program 135. When the received message is determined to be unidentified, the electronic device 101 may display notification of the presence of the unidentified message at a designated location of a chat window 500 of the chat program 135. According to an embodiment of the present disclosure, the electronic device 101 may configure a notification display area 501, where at least one object including the unidentified message is displayed, at a designated location on the lower side of the chat window 500.

The electronic device 101 may display the object using various types of objects such as an image, an icon, and text. For example, the electronic device 101 may display the object using content (e.g., a user profile image 510) designated by a counterpart (or another electronic device) of the chat program 135. According to an embodiment of the present disclosure, referring to an object 503 corresponding to John's chat window displayed in the notification display area 501 of FIG. 5, it may be identified that John's user profile image 510 is used.

For an object (e.g., an object 511, 515, or 517) corresponding to another user's chat window displayed in the notification display area 501, the electronic device 101 may use an image included in the user profile of the corresponding chat window. In addition, when displaying, in the notification display area 501, an object for a chat window (e.g., the chat window 500 of John) which is open in the chat program 135, the electronic device 101 may apply an effect to distinguish between the object and an object corresponding to another chat window. For example, the electronic device 101 may make the size of the object 503 different from that of an object (e.g., the object 511, 515, or 517) corresponding to another chat window, or may apply various effects of changing a color or a border.

When displaying an object for a chat window, the electronic device 101 may display information on the presence of an unidentified message included in the chat window at a designated location near the object. According to an embodiment of the present disclosure, in cases where two unidentified messages exist in the chat window corresponding to the object 511, the electronic device 101 may display notification 513 of the number of unidentified messages, 2, at a designated location near the object or in succession to the object.

Based on a user input, the electronic device 101 may switch the chat window 500 displayed on the display 150 to a chat window corresponding to an object included in the notification display area 501 displayed in the chat window 500. According to an embodiment of the present disclosure, the electronic device 101 may detect a designated user input in the chat window 500. For example, the electronic device 101 may detect an input of touching a particular location of the chat window and dragging the touch through the display 150 (e.g., the touch panel of the display 150) and switch to another chat window designated in the chat window displayed on the display 150 using the detected input. According to an embodiment of the present disclosure, the electronic device 101 may detect a touch and leftward drag 505 input to the message display area while displaying the chat window 500 of John on the display 150.

The electronic device 101 may switch to the chat window corresponding to the object 517 located on the right side of the object 503 corresponding to John's chat window in the notification display area 501 in response to the detected input. According to an embodiment of the present disclosure, the electronic device 101 may detect a touch and rightward drag (not illustrated, for example, see the user input 403 of FIG. 4) input to the message display area while displaying the chat window 4 of John on the display 150. The electronic device 101 may switch to the chat window corresponding to the object 515 located on the left side of the object 503 corresponding to John's chat window in the notification display area 501 in response to the detected input.

When performing the operation of switching the chat window displayed on the display 150 to another chat window, the electronic device 101 may also switch the chat window based on a user input detected in the notification display area 501 without being limited to the operation of switching the chat window based on the user input detected in the message display area. According to an embodiment of the present disclosure, the electronic device 101 may detect an input for selecting (e.g., touching) one of the objects displayed in the notification display area 501. The electronic device 101 may display the chat window corresponding to the selected object on the display 150. For example, the electronic device 101 may detect a user input for selecting the object 517 among the objects displayed in the notification display area 501 of the display 150. The electronic device 101 may display the chat window connected to the selected object 517 on the display 150.

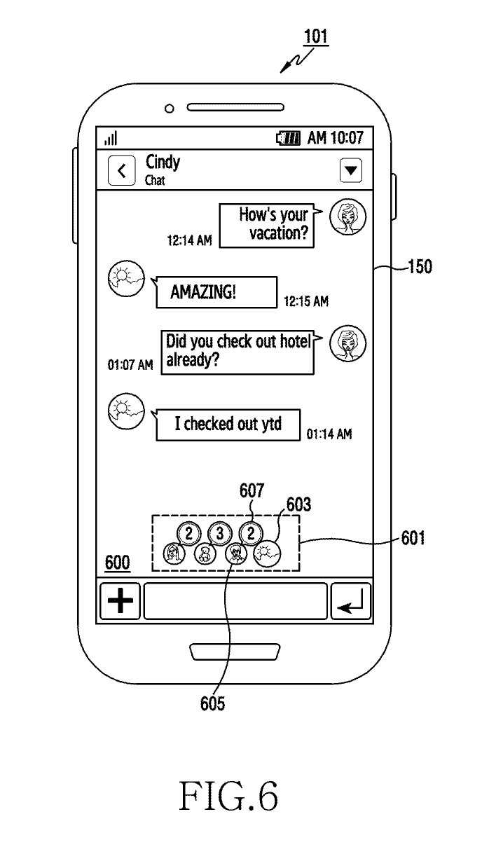

FIG. 6 illustrates an operation of changing an object displayed in a notification display area in an electronic device according to various embodiments of the present disclosure.

Referring to FIG. 6, the electronic device 101 may display or cancel the display of an object (e.g., an object 603, 605) and/or the display of a notification (e.g., notification 607) of the number of unidentified messages corresponding to an object displayed in a notification display area 601 of a chat window 600 displayed on the display 150 based on a user input. For example, the electronic device 101 may cancel the display of an object corresponding to a chat window not including an unidentified message in the notification area 601 displayed in the chat window 600. According to an embodiment of the present disclosure, as illustrated in FIG. 5, the electronic device 101 of FIG. 5 may display the object 503 corresponding to John's chat window 500 in the notification display area 501 of the chat window 500 of John displayed on the display 150. The electronic device 101 may select at least one object (e.g., the object 517 corresponding to Cindy's chat window) among the objects displayed in the notification display area 501 based on a user input (e.g., the touch and leftward drag 505) and display Cindy's chat window (e.g., the chat window 600 of FIG. 6) corresponding to the selected object on the display 150.

When displaying Cindy's chat window 600 on the display 150, the electronic device 101 may cancel the display of the object 503 corresponding to the chat window 500 in the notification display area 601 of the displayed chat window 600. When displaying the chat window corresponding to the selected object based on the user input, the electronic device 101 may identify that the chat window (e.g., the chat window 500 of FIG. 5) corresponding to the object 503 displayed in the notification display area (e.g., the notification display area 501 of FIG. 5) is not in an activated state at present, and may identify that an unidentified message is not included in the chat window 500. In cases where the number of unidentified messages is not displayed for an object displayed in the notification display area 601, the electronic device 101 may cancel the display of the corresponding object (e.g., the object 503 of FIG. 5).

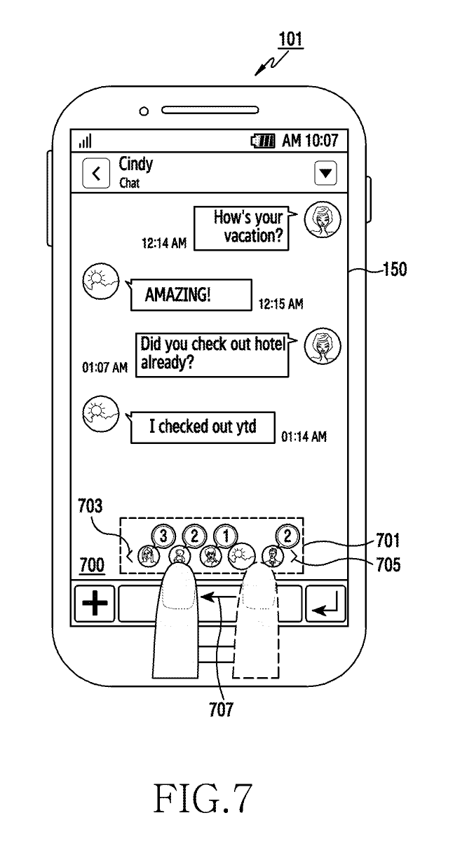

FIG. 7 illustrates an operation of controlling an object displayed in a notification area in an electronic device according to various embodiments of the present disclosure.

Referring to FIG. 7, the electronic device 101, when displaying a predetermined number or more of objects in a notification display area 701 of chat window 700, may provide a method for managing the predetermined number or more of objects. According to an embodiment of the present disclosure, while the number of objects displayed in the notification display area 701 is set to 5, the number of chat windows including an unidentified message of the chat program 135 may be larger than 5 (e.g., 6 or more).

When displaying objects in the notification display area 701, the electronic device 101 may arrange the objects according to the sequence determined based on setting information. According to an embodiment of the present disclosure, the electronic device 101 may arrange objects for chat windows including recently generated unidentified messages according to priorities with respect to the left side of the notification display area. The electronic device 101, after displaying five objects in the notification display area, may also apply priorities (priorities of objects for non-displayed chat windows or an arrangement method) in the same way.

According to various embodiments of the present disclosure, the electronic device 101, without being limited to determining the priorities with respect to the left side as described above, may determine the priorities with respect to the right side based on the setting information or at random. According to an embodiment of the present disclosure, the electronic device 101 may detect an input 707 corresponding to a leftward or rightward scroll in the notification display area 701 in order to identify the remaining objects not displayed in the notification display area 701. The electronic device 101, when detecting the scroll input 707 in the notification display area 701, may scroll (or move) the objects arranged in the notification display area 701 according to the direction of the scroll input 707 to display the remaining objects.

The electronic device 101 is not limited to displaying the non-displayed objects through the scroll input 707 (e.g., a touch and leftward or rightward drag input) for the notification display area 701. For example, the electronic device 101 may detect an input for selecting (e.g., touching) a mark 703 (e.g., an item for indicating a leftward scroll) displayed on the left side of the notification display area 701 or a mark 705 (e.g., an item for indicating a rightward scroll) displayed on the right side of the notification display area 701. The electronic device 101, when detecting an input for the left or right mark 703 or 705, may scroll the objects in a direction according to the corresponding mark to display the other objects not displayed in the notification display area 701.

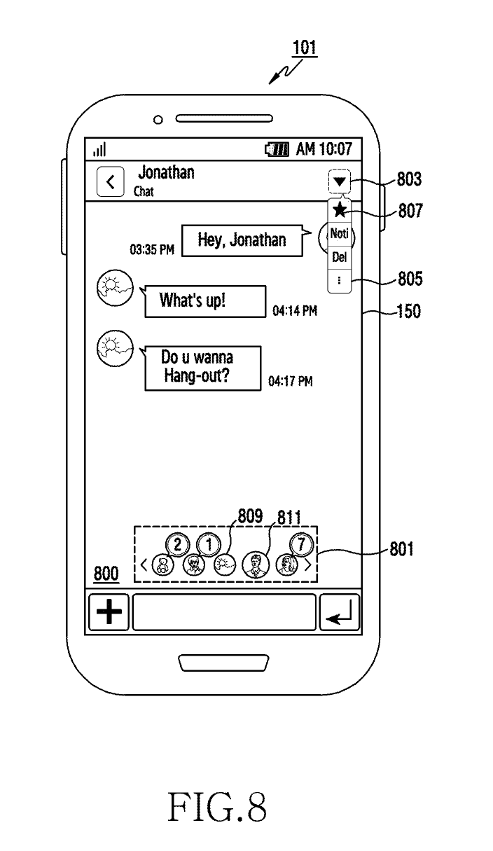

FIG. 8 illustrates an operation of displaying an object in a notification display area in an electronic device according to various embodiments of the present disclosure.

Referring to FIG. 8, the electronic device 101 may select an object 811 displayed in a notification display area 801 while a chat window (e.g., the chat window 700 in FIG. 7) corresponding to an object 809 among the objects displayed in the notification display area 801 (e.g., see the notification display area 701 displayed in the chat window 700 of FIG. 7) is activated. The electronic device 101 may display a chat window 800 corresponding to the object 811 on the display 150 in response to the detection of an input for selecting the object 811.

Referring to the above description, the electronic device 101 may cancel the display of the object 809, corresponding to the chat window 700 not including an unidentified message, in the notification display area 801. In addition, according to various embodiments of the present disclosure, based on setting information, the electronic device 101 may maintain the display of the object 809 instead of cancelling the display of the object 809 in the notification display area. For example, when displaying an object (e.g., the object 809) corresponding to a particular chat window (e.g., the chat window 700 of FIG. 7) in the notification display area 801, the electronic device 101 may set the object 809 to be always displayed in the notification display area (e.g., the notification display area 801) (for example, set the object 809 in a bookmark 807). Even when an object corresponding to a chat window in a state in which the function of the bookmark 807 is activated does not display an unidentified message, the electronic device 101 may display the object in the notification display area 801.

According to various embodiments of the present disclosure, in a method of activating the bookmark function in the electronic device 101, a menu 803 for turning on/off the bookmark 807 may be displayed at a designated location of a particular chat window (e.g., the chat window 800). For example, the electronic device 101, when selecting the functional menu 803 displayed in the chat window 800, may display a list 805 (e.g., a drop menu) including at least one function (e.g., the bookmark 807) included in the functional menu 803. The electronic device 101, when selecting the bookmark 807 in the list 805, may display the object 811 corresponding to the chat window 800 in the notification display area 801 even when the chat window 800 does not include an unidentified message. According to various embodiments of the present disclosure, when displaying an object corresponding to a particular chat window in the notification display area 801, the electronic device 101 may also display objects corresponding to the entire chat window generated in the chat program 135.

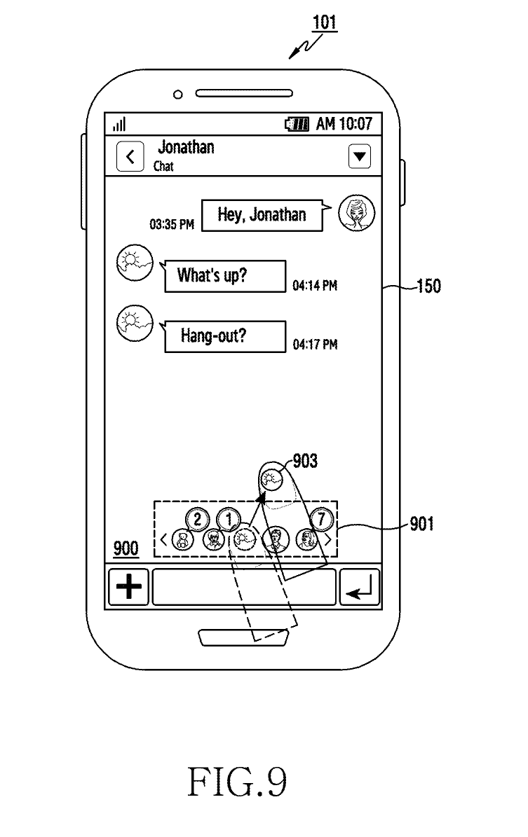

FIG. 9 illustrates an operation of controlling an object included in a notification display area in an electronic device according to various embodiments of the present disclosure.

Referring to FIG. 9, the electronic device 101 may select a particular object among various objects included in a notification display area 901 of a chat window 900 and control the object not to be displayed. According to an embodiment of the present disclosure, the electronic device, when determining an object to cancel the display thereof in the notification display area 901, may turn off a bookmark (e.g., the bookmark 807 of FIG. 8) included in the chat window to determine whether to display the object in the notification display area 901. In addition, the electronic device 101 may select least one object displayed in the notification display area 901 and then move the object to the outside of the notification display area 901 to cancel the display of the object.

For example, it may be assumed that a user wants to cancel the display of an object 903, corresponding to the chat window 700 of FIG. 7, in the notification display area 901. The electronic device 101 may select the object 903, corresponding to the chat window 700 displayed in the notification display area 901, based on a user input and move the selected object 903 to the outside of the notification display area 901 as illustrated in FIG. 9. When detecting an input for deselecting the selected object 903 (e.g., an input for releasing the touch on the object 903) after the object 903 is moved to the outside of the notification display area 901, the electronic device 101 may cancel the display of the object 903 in the notification display area 901.

According to various embodiments of the present disclosure, when cancelling the display of an object displayed in the notification display area 901 based on the above-described method, the electronic device 101 does not restrict the object to an object, such as the object 903, corresponding to a chat window including an unidentified message. For example, the above-described method of cancelling the display of the corresponding object in the notification display area 901 based on the user input may also be applied to an object corresponding to a chat window including an unidentified message. When a new unidentified message is generated in the chat window corresponding to the object (e.g., the object 903) of which the display is cancelled in the notification display area 901 based on the user input, the electronic device 101 may display the object 903 corresponding to the notification display area 901 again or maintain the state in which the display of the object 903 is cancelled, based on setting information.

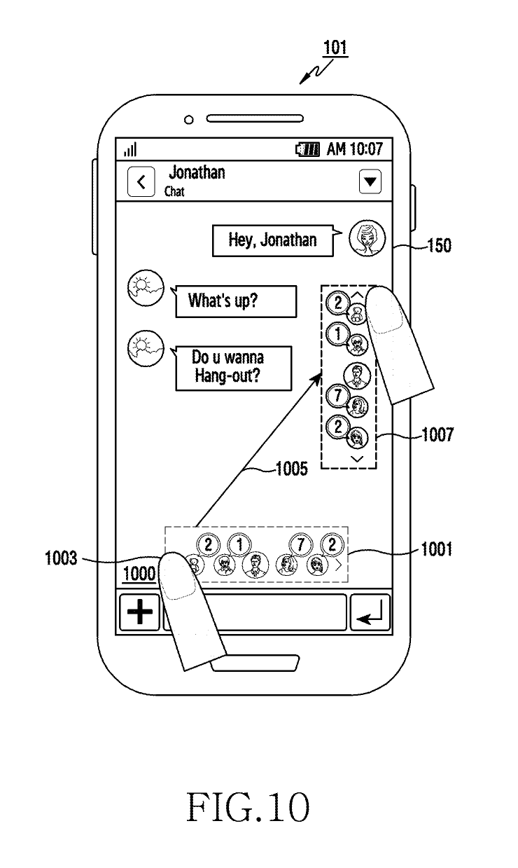

FIG. 10 illustrates an operation of controlling a notification display area displayed in a chat window in an electronic device according to various embodiments of the present disclosure.

Referring to FIG. 10, the electronic device 101, when displaying a notification display area in a chat window (e.g., a chat window 1000) displayed in the chat program 135, may display the notification display area at a designated location based on setting information. For example, a notification display area 1001 of FIG. 10 may have been set to be located on the lower or upper side of a message display area based on the setting information of the electronic device 101. The electronic device 101 may change the location where the notification display area 1001 is displayed in the chat window 1000 based on a user input, or may directly select the notification display area 1001 displayed in the chat window 1000 to change the location where the notification display area 1001 is displayed.

For example, the electronic device 101 may detect a user input (e.g., a touch) for selecting the notification display area 1001 displayed on the lower side of the message display area of the chat window 1000 or a user input (e.g., a touch) for selecting a particular location 1003 of the notification display area 1001 (e.g., the boundary (border) of the notification display area 1001). The electronic device 101 may detect a state in which the user input is maintained for a designated period of time (e.g., two to three seconds) after the detection thereof (for example, a state in which the selection (touch) of the notification display area 1001 is maintained). In cases where the electronic device 101 maintains the selection of the notification display area 1001 for the designated period of time, the electronic device 101 may activate a mode for moving the location of the notification display area 1001.

The electronic device 101 may change the location of the notification display area 1001 displayed on the display 150 according to a user input (e.g., a touch and drag 1005). The electronic device 101, when detecting the release of the user input (e.g., the release of the touch) input to the display 150, may place the notification display area 1001 at the location 1007 where the touch is released and terminate the mode for moving the location of the notification display area 1001.

The electronic device 101, when changing the location of the notification display area 1001, does not restrict the location to an arbitrary location of the chat window 1000. For example, the electronic device 101 may display the notification display area 1001 outside the chat window 1000 or in another window (e.g., a window of another program).

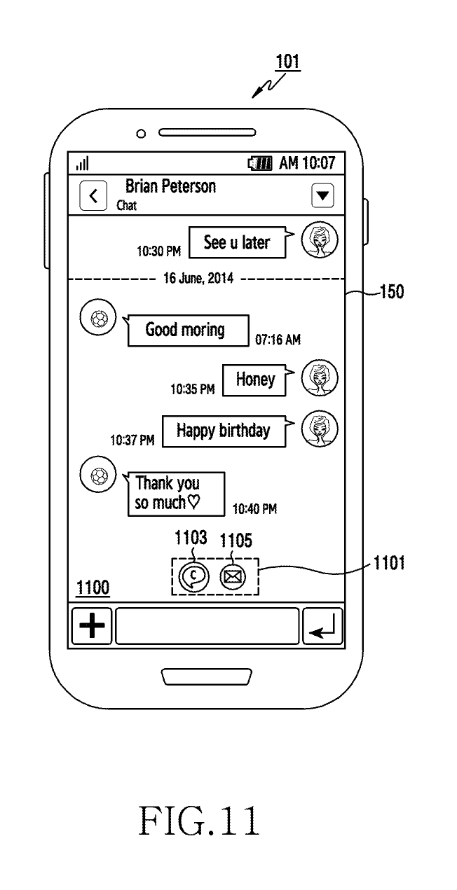

FIG. 11 illustrates an operation of displaying an object of a different program in a notification display area in an electronic device according to various embodiments of the present disclosure.

Referring to FIG. 11, the electronic device 101, when transmitting/receiving a message through the chat program 135, may use a chat window corresponding to a program through which the electronic device may transmit/receive a message to/from a counterpart (e.g., the electronic device 102), such as a chat window of another chat program (e.g., a chat window of a text message program or a chat window of a Social Network Service (SNS) program) as well as the chat window of the chat program 135.

For example, the electronic device 101, when displaying messages that the electronic device exchanges with a counterpart (e.g., Brian Peterson's electronic device 102) through the chat program 135, may display a chat window of a text message program for communication with the counterpart (e.g., Brian Peterson's electronic device 102) instead of a chat window 1000 for displaying messages transmitted/received through the chat program 135. The electronic device 101 may display, in a notification display area 1101 displayed in Brian Peterson's chat window 1100, an object 1103 corresponding to the chat window 1100 where messages are transmitted and received through the chat program 135 and/or an object 1105 corresponding to a chat window where messages are exchanged with Brian Peterson through a text message program.

The electronic device 101, when detecting a user input for selecting the object 1105 displayed in the notification display area 1101 while the chat window 1100 is displayed, may call the chat window in which the electronic device transmits/receives messages to/from Brian Peterson through the text message program, namely, the chat window corresponding to the object 1105, and may display the chat window on the display 150. Accordingly, the electronic device 101, when displaying an object in the notification display area 1001, may also display an object corresponding to a chat window created through at least one other program together with or independently of an object corresponding to a chat window created through the chat program 135.

According to various embodiments of the present disclosure, the electronic device 101 may display at least one object corresponding to a window (a chat window) of the same type of message program (e.g., the chat program 135) as a program corresponding to a window currently displayed on the display 150. In addition, according to various embodiments of the present disclosure, the electronic device 101 may display at least one object corresponding to windows of different types of message programs (e.g., a chat program and a text message program). That is, in various embodiments of the present disclosure, the electronic device 101 may display content, as an object of the notification display area, which corresponds to a window provided by at least some of the same or different types of programs from the program corresponding to the currently displayed window.

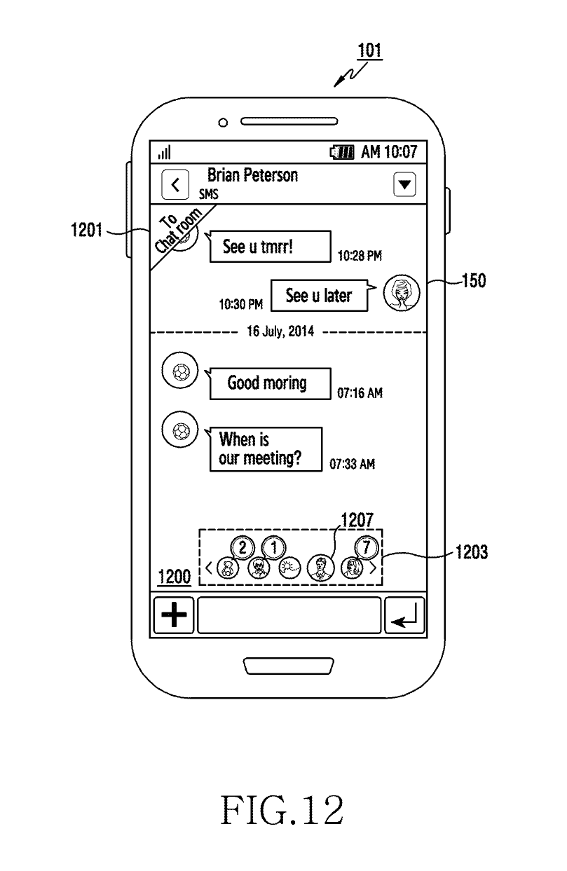

FIG. 12 illustrates an operation of displaying an object corresponding to a chat window of a different program in an electronic device according to various embodiments of the present disclosure.

Referring to FIG. 12, the electronic device 101, when displaying an object for switching a chat window or a notification display area for displaying an object, may separately display an object (e.g., an object 1201) corresponding to a chat window of a different program carried out between the electronic device and the same counterpart. For example, the electronic device 101 may display, on the display 150, a chat window 1200 of a text message program communicating with a particular counterpart (e.g., Brian Peterson) through the chat program 135. The electronic device 101 may display, at a particular location of the chat window 1200, the object 1201 of the chat window including messages exchanged with Brian Peterson through the chat program 135. In various embodiments, the electronic device 101, when selecting the object 1201 based on a user input, may call the chat window including messages exchanged with Brian Peterson and display the same on the display 150.

According to various embodiments of the present disclosure, the electronic device 101 may display information on the currently displayed chat window on the display 150. For example, the electronic device 101 may determine whether the currently displayed chat window is a chat window provided through the chat program 135 or a chat window provided through another program (e.g., a text message program). Based on the determination result, the electronic device 101 may display, in an area for displaying information of the chat window, information as to whether the chat window currently displayed on the display 150 is the chat window of the chat program 135 or the chat window of the other program (e.g., the text message program).

According to various embodiments of the present disclosure, the electronic device 101 may display a notification display area 1203 separately from displaying the object 1201 capable of switching between the chat window 1200 displayed on the display 150 and the chat window provided through the other program (e.g., the text message program) for the same counterpart (e.g., Brian Peterson's electronic device 102). The electronic device 101 may display an object 1207 corresponding to the chat window of counterpart Brian Peterson in the displayed notification display area 1203.

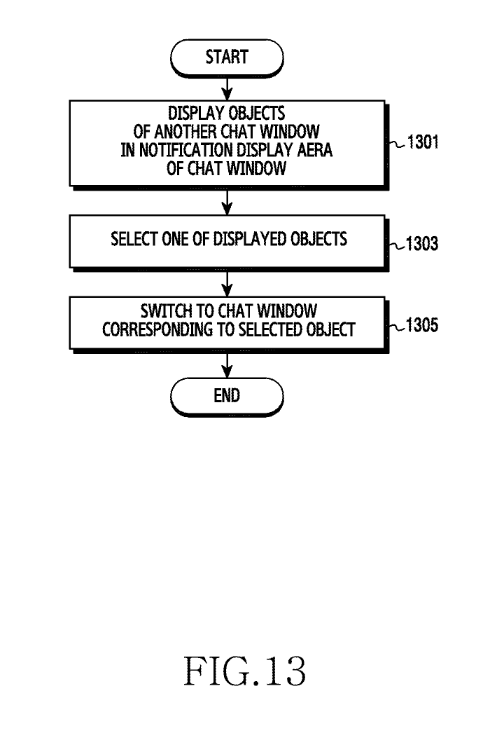

FIG. 13 is a flowchart illustrating an operation of switching a chat window by selecting an object displayed in a notification display area in an electronic device according to various embodiments of the present disclosure.

Referring to FIG. 13, the electronic device 101 may display a notification display area at a designated location of a chat window of a chat program 135 in operation 1301. In various embodiments of the present disclosure, the electronic device 101 may display an object corresponding to a first chat window (e.g., the currently displayed chat window) and at least one object corresponding to a second chat window (e.g., another chat window including unidentified messages) through the notification display area. According to an embodiment of the present disclosure, the electronic device 101, when displaying the objects corresponding to the chat windows in the notification display area, may display an object corresponding to a chat window including at least one unidentified message. The electronic device 101 may refer to setting information, and when it is identified that the unidentified message included in the chat window corresponding to the object displayed in the notification display area is based on a user input, the electronic device 101 may determine to maintain or cancel the display of an object corresponding to a chat window not including an unidentified message displayed in the notification display area. In various embodiments of the present disclosure, the electronic device 101, when displaying the objects in the notification display area, may display objects corresponding to the chat window created through the chat program 135. In addition, the electronic device 101 may also display an object corresponding to a chat window relevant to messages transmitted/received through at least one other program without being limited to the chat window created through the chat program 135.

In operation 1303, the electronic device 101 may select at least one object in the notification display area displayed at the designated location of the chat window. In various embodiments of the present disclosure, the electronic device 101 may control the notification display area to select an object other than the objects displayed in response to the designated number of (e.g., five) objects to be displayed in the notification display area. According to an embodiment of the present disclosure, the electronic device 101, when detecting that a mark (e.g., reference numeral 703 or 705 of FIG. 7) displayed in the notification display area is selected, may display a non-displayed object disposed on the left or right side of the notification display area. In addition, the electronic device 101, when detecting a drag input to the notification display area, may display non-displayed objects corresponding to the progress direction of the drag input. The electronic device 101 may detect an operation of selecting at least one of the objects displayed in the notification display area based on a user input.

In operation 1305, the electronic device 101 may call the chat window corresponding to the selected object. The electronic device 101 may display the called chat window on the display 150. The electronic device 101, when displaying the called chat window on the display 150, may display the chat window as a new layer on the chat window already displayed through the chat program on the display 150. In addition, the electronic device 101 may change the location or the size of the chat window already displayed on the display 150, and then may display the called chat window. In a method of switching the chat window already displayed on the display to the called chat window, the electronic device 101 may cancel the display of the object corresponding to the chat window already displayed on the display based on setting information (e.g., a bookmark) or may maintain the display of the object. In cases where an object selected from the chat window displayed on the display 150 is an object of a chat window corresponding to messages transmitted/received through another program (e.g., a text message program), the electronic device 101 may display the corresponding chat window of the other program on the display 150 through the chat program 135.

According to various embodiments of the present disclosure, the operating method of the electronic device may include an operation of displaying a window, an operation of displaying at least one object in the window, an operation of selecting the object displayed in the window, and an operation of calling and displaying another window connected to the object based on the selected object. The object may include an object corresponding to a window including an unidentified message. The object may be displayed together with the number of unidentified messages included in the window. The operation of selecting the object may be determined by an input detected in a notification display area in which the object is displayed in the window or an area other than the notification display area. Based on an input selected in the area other than the notification display area, an object corresponding to the left or right side of the object, corresponding to the window, which is displayed in the notification display area may be selected. The object may be displayed when a setting is made such that an unidentified message is displayed in the window corresponding to the object. The object may be an object corresponding to a window provided by another program.

Various embodiments of the present disclosure may provide a method of identifying information on (the number of) new messages of another sender in a chat window without exiting the chat window and a chat window switching method (chat window switching based on a new message, chat window switching based on the same user, chat window switching based on a list, and new message chat window switching based on a current chat).

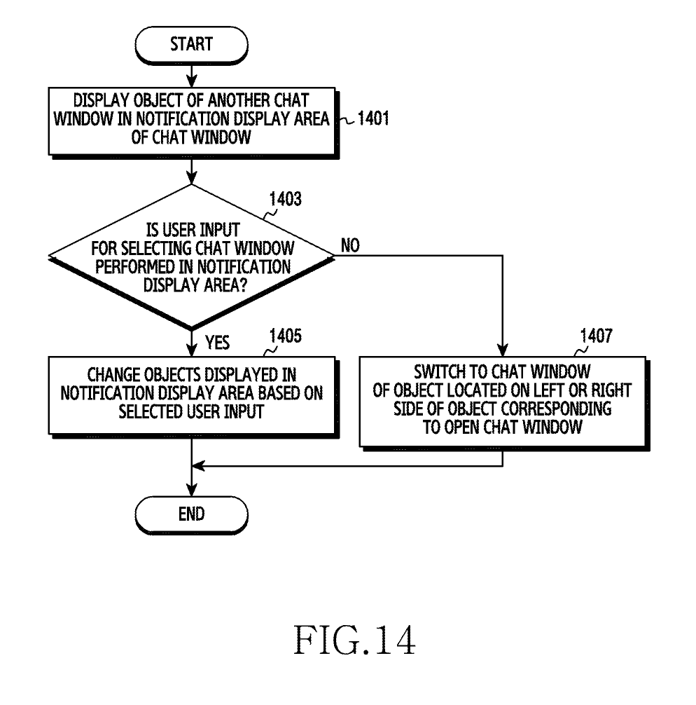

FIG. 14 is a flowchart illustrating an operation of calling another chat window based on a user input detected in a chat window in an electronic device according to various embodiments of the present disclosure.

Referring to FIG. 14, in operation 1401, the electronic device 101 may display, at a designated location of a chat window, an object corresponding to a chat window created through a chat program 135 (or a different message transmission/reception program) or a notification display area including the object. The electronic device 101, when displaying the notification display area in the chat window, may use the same or a similar method to the operation 1301 illustrated in FIG. 13.

In operation 1403, the electronic device 101 may detect a user input entered into the chat window. Based on the user input entered into the chat window, the electronic device 101 may call a chat window different from the chat window displayed on the display 150. According to an embodiment of the present disclosure, the electronic device 101 may detect a user input in a message display area of the chat window. For example, the electronic device 101 may detect an input of touching a designated location and dragging the touch leftward or rightward in the message display area of the chat window. According to an embodiment of the present disclosure, the electronic device 101 may detect a user input in the notification display area of the chat window. For example, the electronic device 101 may detect the above-described drag input in the notification display area of the chat window. The electronic device 101 may perform operation 1405 when detecting a user input in the notification display area of the chat window, or may perform operation 1407 when detecting a user input in the message display area.

In operation 1405, the electronic device 101 may control the objects displayed in the notification display area based on the user input detected in the notification display area of the chat window. According to an embodiment of the present disclosure, the electronic device 101 may have been set to display a designated number of (e.g., five) objects in the notification display area of the chat window. In cases where the number of objects arranged to be displayed in the notification display area is more than five (or six), the electronic device 101 may change the object displayed in the notification display area to another object not displayed in the notification display area based on the user input detected in the notification display area. For example, the electronic device 101 may perform an operation of scrolling the objects displayed in the notification display area rightward based on a touch and leftward drag input detected in the notification display area. The electronic device 101, when detecting an input for selecting at least one of the objects displayed in the notification display area, may call the chat window corresponding to the selected object.

In operation 1407, based on the user input detected in the message display area, the electronic device 101 may display a chat window corresponding to an object located on the left or right side of the currently displayed chat window according to the sequence of the objects displayed in the notification display area. According to an embodiment of the present disclosure, while objects corresponding to chat windows of John, Jonathan, and Brian are arranged in sequence in the notification display area of the chat window, the chat window displayed on the display 150 may be the chat window of Jonathan. The electronic device 101 may detect a touch and leftward drag input entered into Jonathan's chat window, and the electronic device 101 may call and display the chat window corresponding to Brian's object located on the right side of Jonathan in the notification display area.

As described above, the various embodiments of the present disclosure carried out by the electronic device 101 may be operations performed under the control of the processor 120. The electronic device 101 may include a module, separate from the processor 120, which is programmed to control the various embodiments of the present disclosure. The separate module programmed to control the various embodiments of the present disclosure may also operate under the control of the processor 120.

The processor 120 may select an object displayed in a window and display another window connected to the object on a display based on the selected object. The processor 120 may display content, as an object, which corresponds to a window including an unidentified message. The processor 120 may display the number of unidentified messages included in the window together with the object. The processor 120 may select an object using an input detected in a notification display area for displaying objects in the window or an area other than the notification display area. Based on an input selected in the area other than the notification display area, the processor 120 may select an object corresponding to the left or right side of the object, corresponding to the window, which is displayed in the notification display area. The processor 120 may display an object when being set to display an unidentified message in the window corresponding to the object. The processor 120 may display content, as an object, which corresponds to a window provided by another program. The processor 120 may further include an operation of changing the location where an object is displayed.

Although messages transmitted and received in a chat window have been illustrated as one-to-one chat messages in the various embodiments of the present disclosure, this is only for clarity of description, and the present disclosure is not limited thereto. It is apparent to those skilled in the art that the present disclosure can also be applied to multilateral messages without being limited to one-to-one chat messages. Likewise, although the electronic device 101 has been illustrated as a program transmitting/receiving messages and/or a notification display area displayed in a chat window including messages in the above description, it is clear that the present disclosure can also be applied to various programs displaying a window without being limited to the program transmitting/receiving messages.

As described above, according to the various embodiments of the present disclosure, it is possible to display content corresponding to another chat window including an unidentified message in the chat window being displayed on the display, thereby improving inconvenience in chat window switching and allowing an action to be made focusing on a chat. In addition, according to the various embodiments of the present disclosure, it is possible to raise the usability of a message transmission/reception service.

The electronic device according to various embodiments of the present disclosure may include at least one of the above described elements and may exclude some of the elements or further include other additional elements. Further, some of the elements of the electronic device according to various embodiments of the present disclosure may be coupled to form a single entity while performing the same functions as those of the corresponding elements before the coupling.

According to various embodiments of the present disclosure, at least some of the devices or methods as defined by the appended claims and/or disclosed herein may be implemented in the form of hardware, software, firm ware, or any combination (e.g., module or unit) of at least two of hardware, software, and firmware. The “module” may be interchangeably used with a term, such as unit, logic, logical block, component, or circuit. For example, the “module” according to the present disclosure may include at least one of an Application-Specific IC (ASIC) chip, a Field-Programmable Gate Arrays (FPGA), and a programmable-logic device for performing operations which has been known or are to be developed hereinafter. If implemented in software, a computer-readable storage medium (or storage medium readable by a computer) storing at least one program (or programming module) may be provided. The software may, for example, be implemented by instructions stored in a computer-readable storage medium in the form of a programming module. The at least one program may include instructions that cause the electronic device to perform the methods according to various embodiments of the present disclosure as defined by the appended claims and/or disclosed herein. When the command is executed by one or more processors (for example, the processor 120), the one or more processors may execute a function corresponding to the command. The computer-readable storage medium may be, for example, the memory 230. At least a part of the programming module may, for example, be implemented (e.g., executed) by the processor 120. At least a part of the programming module may, for example, include a module, a program, a routine, a set of instructions, or a process for performing at least one function.

In various embodiments of the present disclosure, the computer readable recording medium may include a computer readable recording medium including a program for carrying out an operation of displaying a window, an operation of displaying at least one object in the window, an operation of selecting the object displayed in the window, and an operation of calling and displaying another window connected to the object on the basis of the selected object.

The computer-readable storage medium may include magnetic media such as a hard disc, a floppy disc, and a magnetic tape, optical media such as a compact disc ROM (CD-ROM) and a DVD, magneto-optical media such as a floptical disk, a hardware device specifically configured to store and execute program instructions (e.g., programming module), such as a ROM, a RAM, and a flash memory, an EEPROM, a magnetic disc storage device. Any other type of optical storage device. and a magnetic cassette. Alternatively, any combination of some or all of the may form a memory in which the program is stored. Further, a plurality of such memories may be included in the electronic device. In addition, the program instructions may include high class language codes, which can be executed in a computer by using an interpreter, as well as machine codes made by a compiler.

The operations performed by the modules, programming module, or other elements according to various embodiments of the present disclosure may be executed in a sequential, parallel, repetitive, or heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication module configured to transmit/receive a message;
a display configured to display a window; and
a processor functionally coupled to the communication module and the display, the processor configured to:
select an object displayed in the window, and
display another window corresponding to the object on the display on the basis of the selected object.

2. The electronic device of claim 1, wherein the processor is further configured to display content, as the object, which corresponds to a window including an unidentified message.

3. The electronic device of claim 1, wherein the processor is further configured to display a number of unidentified messages included in the window in conjunction with the object.

4. The electronic device of claim 1, wherein the processor is further configured to select the object in response to an input detected in a notification display area, where the object is displayed in the window, or in an area other than the notification display area.

5. The electronic device of claim 4, wherein the processor, when detecting an input in the area other than the notification display area, is further configured to select an object prior to or subsequent to an object corresponding to the window displayed in the notification display area on the basis of the input.

6. The electronic device of claim 4, wherein the processor is further configured to display an object corresponding to a window including an unidentified message or display an object in response to a setting for constant display.

7. The electronic device of claim 1, wherein the processor is further configured to display content, as the object, which corresponds to a window provided by at least some of the same or different types of programs from a program corresponding to the currently displayed window.

8. The electronic device of claim 4, wherein the processor is further configured to change the location where the object is displayed in response to a user input.

9. The electronic device of claim 8, wherein the processor is further configured to change the location of the notification display area where the object is displayed in response to the user input.

10. An operating method of an electronic device, the operating method comprising:
displaying a window;
displaying at least one object in the window;
selecting the at least one object displayed in the window; and
calling and displaying another window corresponding to the object on the basis of the selected object.

11. The operating method of claim 10, wherein the object displayed in the window comprises an object corresponding to a window including an unidentified message.

12. The operating method of claim 10, wherein the object displayed in the window is displayed in conjunction with a number of unidentified messages included in the window.

13. The operating method of claim 10, wherein the selecting of the object comprises:
selecting the object in response to an input detected in a notification display area, where the object is displayed in the window, or in an area other than the notification display area.

14. The operating method of claim 13, further comprising:
detecting an input in the area other than the notification display area; and
selecting an object prior to or subsequent to an object corresponding to the window displayed in the notification display area on the basis of the input.

15. The operating method of claim 10, wherein the displaying of the object comprises:
displaying an object corresponding to a window including an unidentified message or displaying an object in response to a setting for constant display.

16. The operating method of claim 10, wherein the displaying of the object comprises:
displaying an object corresponding to a window provided by at least some of the same or different types of programs from a program corresponding to the currently displayed window.

17. The operating method of claim 16, further comprising:
displaying content, as the object, which corresponds to the window provided by the at least some programs.

18. The operating method of claim 13, further comprising:
changing the location where the object is displayed in response to a user input.

19. The operating method of claim 18, further comprising:
changing the location of the notification display area where the object is displayed in response to the user input.

20. A non-transient computer readable recording medium comprising a program for carrying out an operation of displaying a window, an operation of displaying at least one object in the window, an operation of selecting the object displayed in the window, and an operation of calling and displaying another window connected to the object on the basis of the selected object.
